(19) United States
(12) Patent Application Publication
(10) Pub. No.: US 2013/0097433 A1
(43) Pub. Date: Apr. 18, 2013

(54) SYSTEMS AND METHODS FOR DYNAMIC RESOURCE MANAGEMENT IN SOLID STATE DRIVE SYSTEM

(71) Applicant: STEC, Inc., Santa Ana, CA (US)

(72) Inventors: Stephen R. Boorman, Santa Ana, CA (US); Omid Nasiby, Santa Ana, CA (US); Sharifuddin Sapuan, Santa Ana, CA (US)

(73) Assignee: STEC, Inc., Santa Ana, CA (US)

(21) Appl. No.: 13/628,426

(22) Filed: Sep. 27, 2012

Related U.S. Application Data
(60) Provisional application No. 61/548,459, filed on Oct. 18, 2011.

(51) Int. Cl. G06F 1/26; G06F 12/14

(52) U.S. Cl. 713/300; 711/103; 711/E12.091; 711/E12.008

(57) ABSTRACT

The disclosed subject matter relates to methods and systems for dynamically controlling the power consumed by solid state drive. One embodiment includes a method that measures the power consumed by the solid state drive system and configures a programmable resource manager to grant the usage/activation of flash memory devices, thereby maintaining the power consumed by the flash memory devices and, as a result, the power consumed by the whole drive, within a specified power budget.

### CROSS-REFERENCE TO RELATED APPLICATIONS

This application claims benefit under 35 U.S.C. §119(e) of the earlier priority date of U.S. Provisional Patent Application No.: 61/548,459, entitled “DYNAMIC POWER MANAGEMENT FOR MULTI-CHANNEL SOLID STATE DRIVE CONTROLLERS,” filed on Oct. 18, 2011, which is hereby incorporated by reference in its entirety.

### BACKGROUND

1. Technical Field

Disclosed systems and methods relate to dynamically managing resources in a solid state drive system.

2. Description of the Related Art

A typical solid-state drive (SSD) system can use multiple flash memory devices to achieve a desired data throughput and storage size. The SSD system can couple these multiple flash memory devices to a memory controller via multiple channels. The number of flash memory devices in an SSD device is determined by a capacity target and/or power consumption of the controller. An important design consideration for such SSD system is power consumption. In many applications, especially in portable applications, managing power and energy consumption of the SSD system is important. Unfortunately, a typical SSD system with multiple flash memory devices does not have a power management system for controlling the power consumption.

### SUMMARY

In accordance with the disclosed subject matter, systems and methods are provided for dynamically managing resources in a solid state drive system.

The disclosed subject matter includes a method of managing power in a solid state drive (SSD) system. The method includes receiving an authorization request from one of a plurality of interfaces, wherein the authorization request comprises a request to authorize access of a flash memory device coupled to the one of the plurality of interfaces to perform a memory operation. The method further includes determining an operating condition of the SSD system, wherein determining the operating condition comprises determining an amount of available resources for the SSD system and an amount of resources required to perform the memory operation, determining if the one of the plurality of interfaces is authorized to perform the memory operation based on the determined operating condition of the SSD system, and if the one of the plurality of interfaces is authorized to perform the memory operation, sending an authorization signal to the one of the plurality of interfaces.

The disclosed subject matter includes a flash memory controller. The controller includes a plurality of interfaces configured to provide communication with one or more flash memory devices, and a processor, in communication with the plurality of interfaces, and configured to run a module stored in non-transitory memory. The module can be configured to receive an authorization request from one of the plurality of interfaces, wherein the authorization request comprises a request to authorize access of a flash memory device coupled to the one of the plurality of interfaces in a solid state drive (SSD) system to perform a memory operation. The module can be further configured to determine an operating condition of the SSD system, wherein determining the operating condition comprises determining an amount of available resources for the SSD system and an amount of resources required to perform the memory operation, determine if the one of the plurality of interfaces is authorized to perform the memory operation based on the determined operation condition of the SSD system, and if the one of the plurality of interfaces is authorized to perform the memory operation, send an authorization signal to the one of the plurality of interfaces.

The disclosed subject matter includes tangible, non-transitory computer readable media. The computer readable media can include machine-readable executable code operable to cause a data processing apparatus. The executable code can be operable to cause the data processing apparatus receive an authorization request from one of a plurality of interfaces, wherein the authorization request comprises a request to authorize access of a flash memory device coupled to the one of the plurality of interfaces in a solid state drive (SSD) system to perform a memory operation. The executable code can also be operable to cause the data processing apparatus to determine an operating condition of the SSD system, wherein determining the operating condition comprises determining an amount of available resources for the SSD system and an amount of resources required to perform the memory operation, determine if the one of the plurality of interfaces is authorized to perform the memory operation based on the determined operation condition of the SSD system, and if the one of the plurality of interfaces is authorized to perform the memory operation, send an authorization signal to the one of the plurality of interfaces.

In one aspect, the method, the apparatus, or the non-transitory computer readable medium can include steps, modules, or executable instructions for determining a priority level associated with the received authorization request.

In one aspect, the method, the apparatus, or the non-transitory computer readable medium can include steps, modules, or executable instructions for retrieving priority level information in the authorization request.

In one aspect, the method, the apparatus, or the non-transitory computer readable medium can include steps, modules, or executable instructions for determining if there are pending authorization requests, received from other interfaces, with higher priority levels compared to the determined priority level of the received authorization request.

In one aspect, the resources comprise power.

In one aspect, the method, the apparatus, or the non-transitory computer readable medium can include steps, modules, or executable instructions for receiving power consumption information from a power sensor and determining an amount of additionally available power for the SSD system.

In one aspect, the method, the apparatus, or the non-transitory computer readable medium can include steps, modules, or executable instructions for receiving the power consumption information when a power consumption of the SSD system is above a predetermined threshold.

In one aspect, the method, the apparatus, or the non-transitory computer readable medium can include steps, modules, or executable instructions for determining a type of the flash memory device.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a solid-state drive (SSD) system in accordance with certain embodiments of the disclosed subject matter.

FIG. 2 illustrates an SSD system implementing a dynamic power control scheme in accordance with certain embodiments of the disclosed subject matter.

FIG. 3 illustrates a method of managing power in accordance with certain embodiments of the disclosed subject matter.

### DETAILED DESCRIPTION

The disclosed subject matter includes systems and methods for controlling resource consumption of a solid state drive (SSD) system. In many applications, especially in portable applications, managing resource consumption of the SSD system is important due to limited resource budget available to the SSD system. For example, the available resources such power and energy budgets for battery operated SSD system can be limited. Therefore, designers often design the SSD system to limit the resource consumption to a predetermined threshold. For example, a typical 2.5-inch serial attached small computer system interface (SAS) drive preferably operates around about 9 Watts. However, the SSD system oftentimes does not have a mechanism for controlling the resource consumption dynamically.

The disclosed subject matter includes an SSD system that is configured to dynamically control the resource consumption. In SSD systems, the flash memory devices are one of the main consumers of resources, such as power and energy. Therefore, the disclosed SSD system is configured to dynamically arbitrate resources consumed by the flash memory devices. This resource management scheme can set a limit to resources consumed by the SSD system.

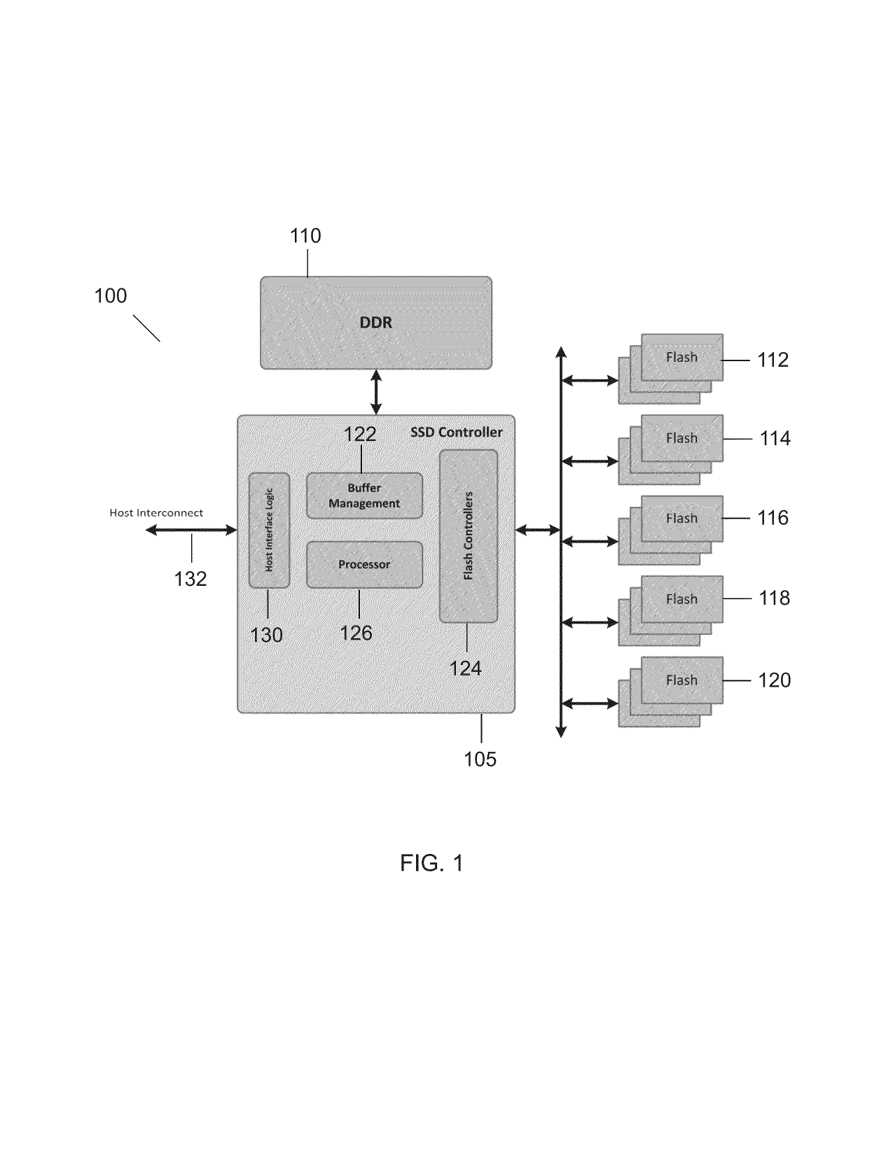

A solid-state drive (SSD) system can include multiple flash memory devices to achieve a desired data throughput and storage size. FIG. 1 illustrates an SSD system in accordance with certain embodiments of the disclosed subject matter. The SSD system can include a solid state drive controller 105, external memories 110, and flash memory devices 112-120. The external memories 110 can include double data rate (DDR) memories, and the SSD controller 105 can include a buffer management device 122, a flash controller 124, a processor 126, host interface logic 130 and a host interconnect 132.

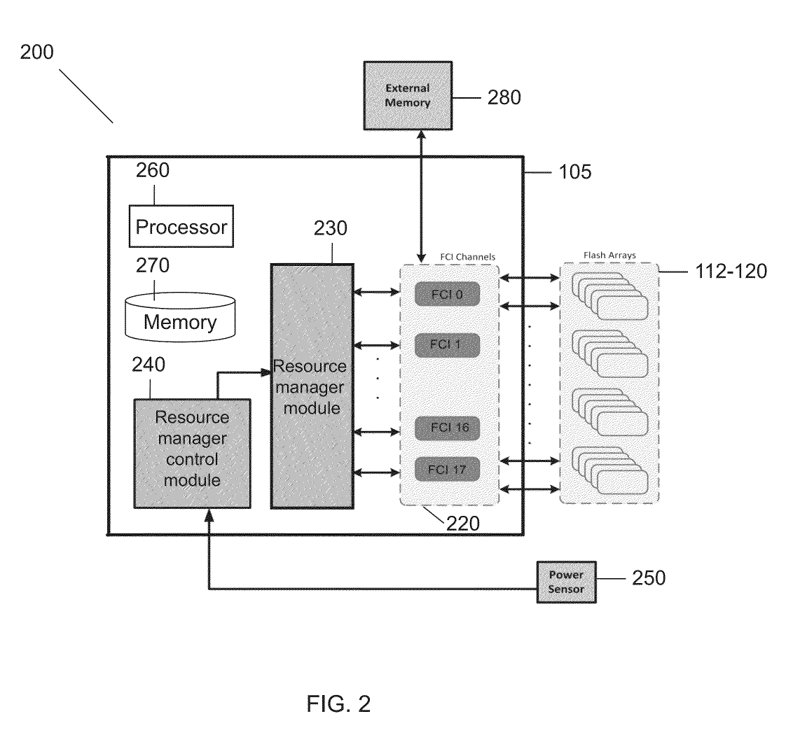

FIG. 2 illustrates an SSD system implementing a dynamic resource control scheme in accordance with some embodiments of the disclosed subject matter. The SSD system 200 can include an SSD controller 105, a plurality of flash memory devices 112-120, a power sensor 250, a processor 260, an internal memory 270, and an external memory 280. The SSD controller 205 can include a plurality of channels 220 for coupling to the flash memory devices 112-120, a resource manager module 230, and a resource manager control module 240. The plurality of channels 220 can include an interface, which can include a flash channel interface (FCI.) The internal memory 270 can maintain the software for operating the resource manager module 230 and the resource manager control module 240. The processor 260, coupled to the internal memory 270, can retrieve software and operate the software.

In some embodiments, the flash memory devices 112-120 can be standard flash memory devices and can be configured to communicate with the resource manager module 230 through the plurality of channels 220. Each channel can be configured to communicate with a unique one or set of flash memory devices 112-120. One purpose of having multiple channels is to increase the throughput (mega bytes per second) and the storage capacity (Giga Bytes) of the SSD system 200. In some embodiments, each of the flash memory devices 112-120 also can have a corresponding flash channel controller to communicate with the embedded processor 240.

The plurality of channels 220 can provide an input and/or output mechanism to provide communication with the flash memory devices 112-120. The plurality of channels 220 can be implemented in hardware to send and receive signals in a variety of mediums, such as optical, copper, and wireless, and in a number of different protocols some of which may be non-transient.

The resource manager module 230 can perform a dynamic resource management of the SSD system 200. In some embodiments, the resource manager module 230 can include a power manager module that is configured to perform a dynamic power management of the SSD system 200. The resource manager module 230 can be configured to communicate with flash memory devices 112-120 through the plurality of channels 220, and the resource manager module 230 can be programmed and controlled by the resource manager control module 240. In some embodiments, the resource manager module 230 can be a part of hardware implemented in the SSD system 200.

The resource manager control module 240 can be configured to control the resource manager module 230. The resource manager control module 240 can store one or more of the following information: the available resources for the SSD system 200, a level of power consumed by each flash memory device 112-120, memory operational data relating to read, write, and erase operations, for example, and a priority level of operations performed by flash memory devices 112-120. Memory operational data can include information on the power requirements or power consumption of a flash memory device during read, write, and erase operations. For example, memory operational data can indicate that the power requirement for the flash memory device during a read operation is about 100 mW; that the power requirement for the flash memory device during a write operation is about 150 mW; that the power requirement for the flash memory device during an erase operation is about 200 mW. In some cases, memory operational data can include the number of read, write, and erase operations that can be performed with a given level of available resources. For example, if the available resources for the SSD system is 9 W and the power requirements for read, write, and erase operation are about 100 mW, 150 mW, and 200 mW, respectively, then the memory operational data can indicate that the flash memory device can perform about 90 read operations, 60 write operations, or 45 erase operations, respectively.

In some embodiments, the resource manager control module 240 can be configured to communicate with the resource manager module 230 and the power sensor 250. The resource manager control module 240 can enable the resource manager module 230 to use one or more of the above information to monitor activities on the SSD system 200 and allow an execution of a new operation to be started when there are enough resources to execute the new operation.

The resource manager module 230 and the resource manager control module 240 can be implemented in software. The software can be stored and/or loaded on memory 270 such as a non-transient computer readable medium, a non-transitory computer readable medium, a programmable read only memory (PROM), flash memory, or a magnetic disk that is readable by a general or special purpose-processing unit to perform the processes described in this document. In some embodiments, the software needed for implementing the resource manager module 230 and the resource manager control module 240 can be implemented using a high level procedural or an object-orientated language such as C, C++, C#, Java, or Perl. The software may also be implemented in assembly language. The software can run on a processor 260 that executes software instructions or computer code. The processor 260 can include any microprocessor (single core or multiple cores), system on chip (SoC), microcontroller, digital signal processor (DSP), graphics processing unit (GPU), or any other integrated circuit capable of processing instructions such as an x86 microprocessor. The resource manager module 230 and the resource manager control module 240 may also be implemented in hardware using an application specific integrated circuit (ASIC), programmable logic array (PLA), or any other integrated circuit.

The power sensor 250 can be a conventional power sensor. In some embodiments, the power sensor 250 can determine the power consumed by the entire drive. In other embodiments, the power sensor 250 can determine the power consumed by each of the flash memory device 112-120 independently. The power sensor 250 can be configured to provide the power consumption information to the resource manager control module 240, which can use the information to modify configuration of the resource manager module 230.

The external memory 280 can be configured to communicate with the plurality of channels 220 and can be used for storing both data and meta-data. In some embodiments, the external memory 280 can be a double data rate (DDR) 2/3 memory device.

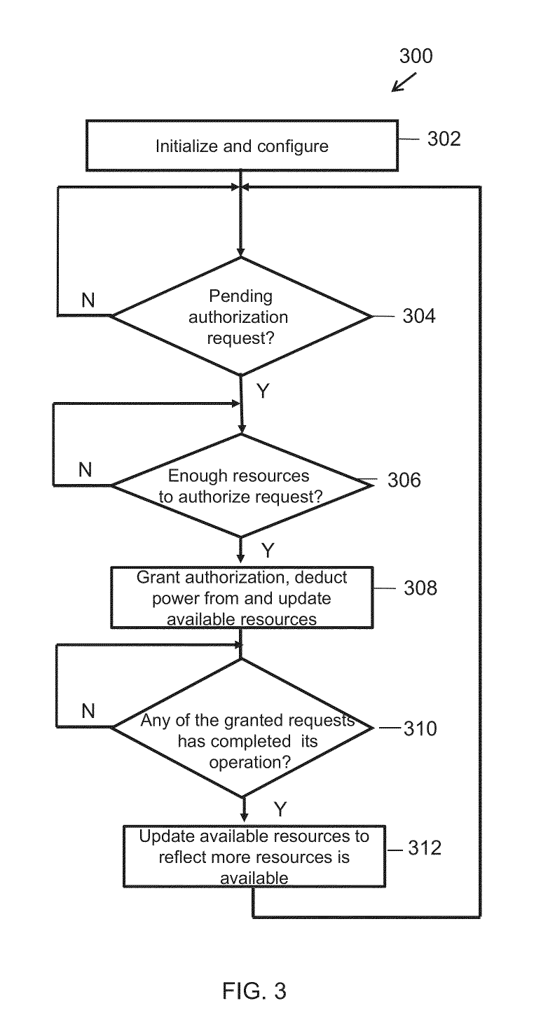

FIG. 3 illustrates a method 300 of power management in accordance with an embodiment of the disclosed subject matter. The method 300, however, is exemplary. The method 300 can be altered, e.g., by having steps added, changed, removed, or rearranged. One or more of the steps may be implemented on solid state drive controller 105, flash controller 124, and/or resource manager module 203. The method 300 may begin at step 302.

In step 302, when the SSD system 200 is powered up, the resource manager control module 240 can initialize and configure the resource manager module 230. The configuration of the resource manager module 230 can include setting one or more parameters of a configuration table. The configuration table may reside in the resource manager module 230. The configuration table may include one or more of the following parameters: the available resources for the SSD system, the SSD system energy budget, the average power requirement to perform a memory operation, and priority levels associated with each of the flash memory device and/or with each of the memory operations.

In some embodiments, the priority level associated with a memory operation may depend on the device issuing the request. For example, a read operation request issued by a host device may be given a higher priority than a read operation request issued by a firmware, which simply checks the operation of the SSD system in the background. Once the resource manager control module 240 completes the initialization and the configuration of the resource manager module 230, the interface 220 can start its normal operations.

When an interface 220 receives an instruction, e.g., from an application firmware, to perform an operation, the interface 220 can determine whether the instruction requires activating one or more flash memory devices 112-120. If the instruction requires activating one or more flash memory devices 112-120, the interface 220 can send an authorization request to the resource manager module 230 before the interface 220 starts executing the received instruction.

In some embodiments, an authorization request can further include one or more of the following parameters: a power requirement of a memory operation associated with the authorization request and a priority level associated with the authorization request. In some embodiments, the power requirement of a memory operation can be indicated using a power weight. For example, if a read operation requires 100 mW, a write operation requires 150 mW, and an erase operation requires 200 mW of power, then the values of 1, 2, and 3 may be assigned as the power weights for these operations, respectively. The power weights and the associated power requirement levels may be maintained in the configuration table. When the resource manager module 230 receives the power weight in the authorization request, the resource manager module 230 can convert the power weight into a value of power consumption associated with the power weight.

Once the interface 220 sends an authorization request, an authorization signal from the resource manager module 230 may be issued before the interface 220 can proceed to perform the memory operation associated with the authorization request. The authorization signal can be a signal, sent by the resource manager 230 to the interface 220, allowing the interface 220 to proceed with the requested operation.

In step 304, it may be determined if there is a pending authorization request. In some embodiments, the resource manager module 230 continuously monitors pending authorization requests. In other embodiments, the resource manager module 230 periodically monitors pending authorization requests. If there is a pending authorization request, the method 300 proceeds to step 306, otherwise the method 300 proceeds back to step 304.

In some cases, the resource manager module 230 can receive multiple authorization requests from multiple interfaces within a short period of time. In such cases, the resource manager module 230 may not be able to address all the authorization requests as they arrive at the resource manager module 230. To address this issue, in some embodiments, the resource manager module 230 can maintain a pending request buffer for authorization requests. A pending request buffer can prioritize or order the requests in the resource manager module 230. The pending request buffer may also contain a list of pending authorization requests that needs to be carried out in subsequent operations. For example, interface 220 may be configured to maintain a queue of instructions to be executed by the memory devices via the interface 220. In this case, the interface 220 may send authorization requests for instructions in the queue, even if they do not need to be executed immediately.

In some embodiments, the order of the authorization requests can be organized based on the time at which the associated requests were received, such as a first-in-first-out basis. In some embodiments, the order of an authorization request can be sorted or re-prioritized based on the time waiting in the pending request buffer. For example, if an authorization request was in the buffer for a long period of time, e.g., more than 10 milliseconds, its priority level may be increased and put in front of the queue.

In some embodiments, the order of the requests can be organized based on the priority level associated with the requests. For example, if the device priority level of the most recent request is higher than the priority level of other requests, the most recent request may be processed right away and put in front of the queue of the pending request buffer. If a request does not include priority level information, the configuration table for priority levels may be used to determine the priority level and the request then may be sorted or ordered in the queue appropriately. When a pending request buffer is used, the resource manager module 230 can determine if there is a pending authorization request by determining if the pending request buffer is empty.

In step 306, it may be determined whether there are enough available resources to authorize a request. Operating conditions of the SSD system 200 may be used to determine if there is enough power to grant a request. The operating conditions can include total power available to the SSD system 200, a power supply voltage of the SSD system 200, a maximum current rating of the SSD system 200, a maximum power rating of the SSD system 200, an operating temperature of the SSD system 200, or a priority level associated with the received authorization request. In some embodiments, a configuration table tracks and maintains the amount of available resources for the SSD system. In some embodiments, the configuration table may also be used to obtain the average power requirement associated with a request. The obtained power requirement may then be compared to the available resources to determine if the SSD system has adequate resources. If there is enough resources to perform the authorization request the method 300 proceeds to step 308, otherwise the method proceeds back to step 306 and waits until the SSD system has adequate resources to grant the request.

In step 308, the request may be granted. An authorization signal may be sent to the interface 220 to indicate the request is granted. In one embodiment, the power requirement of the granted request is deducted from the available resources. The value of the available resources is updated to reflect the use of power that was granted to the request and a drop in available resources. In some embodiments, the values of the available resources and the power requirement can be measured by power sensors.

In some embodiments, information regarding the power requirements may be obtained from a list in the configuration table. The information may also be obtained from a plurality of lists that are kept for different flash memory devices. The power requirement of a memory operation can vary between flash memory devices and types of devices. Therefore, different lists for different flash memory devices may be used. In this way, better accurate accounts of power requirements can be attained and events in which the resource manager module 230 may authorize a memory operation that has a power requirement exceeding the SSD system's available resources can significantly be reduced.

In some embodiments, the resource manager module 230 is configured to determine the types of the flash memory devices associated with the authorization request. In some embodiments, information regarding the types of flash memory devices is included in the authorization request.

In some embodiments, the power requirement of a memory operation may change due to process, temperature and voltage variations. To address this issue, a measurement of the power requirement can be obtained using a feedback system. The feedback system allows real-time collection of power consumption relating to each of the flash memory devices and each of the flash memory operations. This real-time power consumption information then can be used to better estimate future power requirements and power allocations. In some embodiments, actual power consumption for each flash memory device is measured.

The feedback system may include the power sensor 250, which can measure the power consumption of the SSD system 200 in real-time. In some embodiments, the power sensor 250 can provide this measured power consumption information to the resource manager control module 240. The resource manager control module 240 can relay this power consumption information to the resource manager module 230, which in turn can use the power consumption information to update its measure on how much additional power/energy is available to the SSD system 200. In some embodiments, the power sensor 250 can measure the power consumption of all the flash memory devices 112-120. In other embodiments, the power sensor 250 can measure the power consumption of each of the flash memory devices 112-120 independently.

In another embodiment, the power sensor 250 can be configured to send an alert signal to the resource manager control module 240 when the power consumed by the SSD system 200 is above a predetermined threshold. Upon receiving the alert signal from power sensor 250, the resource manager control module 240 can trigger the power manger module 230 to reduce its measure on how much additional power/energy is available to the SSD system 200. Subsequently, the resource manager module 230 can use the updated value of the SSD system's available resources to service any additional requests.

In step 310, it may be determined whether any of the granted requests has completed its operation. If an operation of a granted request is completed, the method 300 then proceeds to step 312, where the value of the SSD system's available resources is updated. In one embodiment, the power requirement allocated to the completed operation is credited back to the available resources. The method 300 then may proceed back to step 304. If an operation is not completed, the method 300 proceeds back to step 310 to continually check if the operation is completed.

With the exemplary embodiments, not only is the resource consumption of the flash memory devices reduced, but also the dynamic resource consumption of the controller and the external memories 260 are reduced. The rate of external memory access can depend on the activity on flash memories. When resource management is enabled, the resource manager 230 can limit the flash memory activities and as a result the request rate for accessing the external memory can also be reduced, resulting in less resource consumption by the external memory 280. This resource consumption reduction can allow the SSD system to stay within allocated resource budget range.

Those of skill in the art would appreciate that the various illustrations in the specification and drawings described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (for example, arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

The terms “SSD”, “SSD device”, and “SSD drive” as used herein are meant to apply to various configurations of solid state drive devices equipped with SSD controllers a in accordance with one or more of the various embodiments of the disclosed subject matter. It will be understood that other types of non-volatile mass storage devices in addition to flash memory devices may also be utilized for mass storage.

The terms “power”, “resources”, and “resource consumption” as used herein may include, but is not intended to be limited to, the rate of energy consumption. The terms may be used interchangeably with and/or include energy, and the actual electrical energy being consumed.

We claim:

1. A method of managing power in a solid state drive (SSD) system, the method comprising:
receiving an authorization request from one of a plurality of interfaces, wherein the authorization request comprises a request to authorize access of a flash memory device coupled to the one of the plurality of interfaces to perform a memory operation;
determining an operating condition of the SSD system, wherein determining the operating condition comprises determining an amount of available resources for the SSD system and an amount of resources required to perform the memory operation;
determining if the one of the plurality of interfaces is authorized to perform the memory operation based on the determined operating condition of the SSD system; and
if the one of the plurality of interfaces is authorized to perform the memory operation, sending an authorization signal to the one of the plurality of interfaces.

2. The method of claim 1, wherein determining the operating condition of the SSD system further comprises determining a priority level associated with the received authorization request.

3. The method of claim 2, wherein determining the priority level associated with the received authorization request comprises retrieving priority level information from the authorization request.

4. The method of claim 2, wherein determining the operating condition of the SSD system comprises identifying pending authorization requests, received from other interfaces, with higher priority levels compared to the determined priority level of the received authorization request.

5. The method of claim 1, wherein the resources comprise power.

6. The method of claim 5, wherein determining the amount of available resources for the SSD system comprises receiving power consumption information from a power sensor and determining an amount of additionally available power for the SSD system.

7. The method of claim 6, wherein receiving the power consumption information from the power sensor comprises receiving the power consumption information when a power consumption of the SSD system is above a predetermined threshold.

8. The method of claim 5, wherein determining the amount of resources required to perform the memory operation comprises determining a type of the flash memory device.

9. A flash memory controller comprising:
a plurality of interfaces configured to provide communication with one or more flash memory devices; and
a processor, in communication with the plurality of interfaces, and configured to run a module stored in non-transitory memory that is configured to:
receive an authorization request from one of the plurality of interfaces, wherein the authorization request comprises a request to authorize access of a flash memory device coupled to the one of the plurality of interfaces in a solid state drive (SSD) system to perform a memory operation;
determine an operating condition of the SSD system, wherein determining the operating condition comprises determining an amount of available resources for the SSD system and an amount of resources required to perform the memory operation;
determine if the one of the plurality of interfaces is authorized to perform the memory operation based on the determined operation condition of the SSD system; and
if the one of the plurality of interfaces is authorized to perform the memory operation, send an authorization signal to the one of the plurality of interfaces.

10. The flash memory controller of claim 9, wherein the operating condition of the SSD system further comprises a priority level associated with the received authorization request.

11. The flash memory controller of claim 10, wherein the priority level associated with the received authorization request is included in the received authorization request.

12. The flash memory controller of claim 10, wherein the operating condition of the SSD system further comprises whether or not there are pending authorization requests, received from other interfaces, with higher priority levels compared to the determined priority level of the received authorization request.

13. The flash memory controller of claim 9, wherein the resources comprise power.

14. The flash memory controller of claim 13, wherein the module is configured to receive power consumption information from a power sensor and determine an amount of additionally available power for the SSD system.

15. The method of claim 9 wherein the module is configured to determine a type of the flash memory device.

16. Tangible, non-transitory computer readable media comprising machine-readable executable code operable to cause a data processing apparatus to:
receive an authorization request from one of a plurality of interfaces, wherein the authorization request comprises a request to authorize access of a flash memory device coupled to the one of the plurality of interfaces in a solid state drive (SSD) system to perform a memory operation;
determine an operating condition of the SSD system, wherein determining the operating condition comprises determining an amount of available resources for the SSD system and an amount of resources required to perform the memory operation;
determine if the one of the plurality of interfaces is authorized to perform the memory operation based on the determined operation condition of the SSD system; and
if the one of the plurality of interfaces is authorized to perform the memory operation, send an authorization signal to the one of the plurality of interfaces.

17. The computer readable media of claim 16, further comprising executable code operable to cause the data processing apparatus to determine a priority level associated with the received authorization request.

18. The computer readable media of claim 16, further comprising executable code operable to cause the data processing apparatus to identify pending authorization requests, received from other interfaces, with higher priority levels compared to the determined priority level of the received authorization request.

19. The computer readable media of claim 16, further comprising executable code operable to cause the data processing apparatus to receive power consumption information from a power sensor and determine an amount of additionally available power for the SSD system.

20. The computer readable media of claim 16, further comprising executable code operable to cause the data processing apparatus to determine a type of the flash memory device.
